(19) United States
(12) Patent Application Publication
(10) Pub. No.: US 2026/0314872 A1
(43) Pub. Date: Oct. 15, 2026

(54) Cooktop Remote-Monitoring Device

(71) Applicant: Daniel Simmons, Jackson Heights, NY (US)

(72) Inventor: Daniel Simmons, Jackson Heights, NY (US)

(21) Appl. No.: 19/281,867

(22) Filed: Jul. 28, 2025

Related U.S. Application Data
(60) Provisional application No. 63/787,427, filed on Apr. 11, 2025.

(51) Int. Cl. A47J 36/32; H04N 7/18; H04N 23/51; H04N 23/57; H04N 23/695; H04R 1/02

(52) U.S. Cl. CPC A47J 36/321; H04N 7/18; H04N 23/51; H04N 23/57; H04N 23/695; H04R 1/028; A47J 2202/00

(57) ABSTRACT

A cooktop remote-monitoring device is provided. The device is designed to enable real-time remote observation, hazard detection, and user notification during stovetop cooking. The device comprises a camera enclosed in a hemispherical protective dome. The dome and/or camera assembly is configured to rotate and tilt, wherein the dome is constructed from optically transparent materials and may be treated with a hydrophobic nano-coating in combination with a thermal regulation element to ensure optical clarity. The device may further comprise multiple environmental sensors including but not limited to thermal, optical, gas, humidity, and acoustic sensors, which transmit data via integrated wireless communication modules. An integrated smoke detector and speaker module may also be included for localized alerts. The device is further comprised of a mobile application that may support video streaming, remote control, timer management, and artificial intelligence-based event detection.

### CROSS REFERENCE TO RELATED APPLICATION

The present application claims priority to, and the benefit of, U.S. Provisional Application No. 63/787,427, which was filed on Apr. 11, 2025, and is incorporated herein by reference in its entirety.

### FIELD OF THE INVENTION

The present invention relates generally to the field of cooking. More specifically, the present invention relates to a device designed to enable real-time remote observation, hazard detection, and user notification during stovetop cooking without having to be physically present near the stovetop. Accordingly, the present disclosure makes specific reference thereto. Nonetheless, it is to be appreciated that aspects of the present invention are also equally applicable to other like applications, devices, and methods of manufacture.

### BACKGROUND

Unattended stovetop cooking is a common occurrence in residential and commercial kitchens, often resulting from individuals stepping away from the cooking area for extended or brief periods. This behavior introduces significant safety hazards, including the potential for fire, smoke generation, gas leaks, and overcooking or burning of food. Traditional methods of managing cooking processes rely heavily on direct observation and manual intervention, which limits flexibility and demands constant attention. Although kitchen timers and range hoods provide limited assistance, they fail to address the root issue of real-time visibility and situational awareness during cooking. Furthermore, contemporary smart home systems often lack specialized, localized monitoring solutions for the stove area itself. As a result, users face an increased risk of property damage, food waste, and safety incidents. The integration of sensors and camera systems into cooking environments has not been effectively tailored to address the unique operational characteristics of stovetop use. A need therefore arises for a specialized solution that allows users to remotely observe, receive alerts, and control certain cooking-related parameters to reduce the risks associated with unattended cooking and promote safer and more efficient kitchen environments.

Therefore, there exists a long-felt need in the art for a cooktop remote-monitoring device that enables individuals to visually monitor stovetop activities in real time from remote locations. There also exists a long-felt need in the art for a cooktop remote-monitoring device that incorporates environmental and thermal sensors to detect hazardous conditions during cooking. Moreover, there exists a long-felt need in the art for a cooktop remote-monitoring device that provides alert functionalities and remote control features to enhance user responsiveness and cooking safety.

The subject matter disclosed and claimed herein, in one embodiment thereof, comprises a cooktop remote-monitoring device. The device is designed to enable real-time remote observation, hazard detection, and user notification during stovetop cooking. The device comprises a camera enclosed in a hemispherical protective dome. The dome and/or camera assembly is configured to rotate and tilt, wherein the dome is constructed from optically transparent materials and may be treated with a hydrophobic nano-coating in combination with a thermal regulation element to ensure optical clarity. The device may further comprise multiple environmental sensors including but not limited to thermal, optical, gas, humidity, and acoustic sensors, which transmit data via integrated wireless communication modules. The main body includes a fastener for secure attachment to kitchen fixtures, utilizing magnetic, adhesive, or mechanical interfaces. Power is provided by a rechargeable battery, while a built-in display and manual control interface allow for direct operation. An integrated smoke detector and speaker module may also be included for localized alerts. The device is further comprised of a mobile application that may support video streaming, remote control, timer management, and artificial intelligence-based event detection.

In this manner, the cooktop remote-monitoring device of the present invention accomplishes all the foregoing objectives and provides a user with the ability to monitor stovetop conditions remotely through a rotatable, zoom-capable camera system equipped with visibility enhancements and protective features. The additional possible integration of thermal, optical, acoustic, and gas sensors allows for real-time detection of dangerous or abnormal cooking conditions, while wireless data transmission ensures continuous user engagement regardless of physical proximity to the cooktop. The mobile application interface, combined with automated alert generation and manual control features, thereby addresses the practical need for active stovetop management when direct supervision is not feasible. As a result, the cooktop remote-monitoring device enhances kitchen safety, reduces the likelihood of unattended cooking incidents, and improves overall cooking efficiency.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cooktop remote-monitoring device. The device is designed for real-time visual monitoring, event detection, and remote alert communication during cooking operations, wherein the device enhances kitchen safety, prevents risks associated with unattended cooking, and improves efficiency through remote oversight and automation.

The device is comprised of a camera configured for remote visual monitoring. The camera may be a digital video type with features such as but not limited to zoom, wide-angle view, night vision, infrared illumination, and automatic exposure. The camera is housed in a hemispherical protective dome that may be rotatable horizontally and tiltable vertically, driven by at least one motor. Control of rotation and tilt may be manual via a mobile application or autonomous through embedded software responding to sensor triggers. The protective dome is comprised of transparent or translucent materials and may be coated with a hydrophobic nano-coating to resist condensation, splatter, and steam.

The device is comprised of at least one environmental sensor configured to monitor cooking-related parameters such as temperature, smoke, humidity, gas concentration, and sound. The sensor outputs may be transmitted to the mobile application using wireless communication modules such as Bluetooth, Wi-Fi, or Zigbee.

The device body may include a fastener enabling secure attachment to kitchen structures. The fastener may use magnetic, suction, hook-and-loop, or adhesive mechanisms, and may include a protective surface for anti-slip and anti-abrasion. An alternative mounting configuration may feature a detachable adhesive disk with an embedded magnet, allowing for repositioning.

Power is supplied by an internal rechargeable battery, which may be charged via a USB-C port, pogo-pin connector, or wireless charging coil. The device may include a power button and LED indicators for battery status. An integrated electronic display screen may provide information such as timers, diagnostics, and sensor warnings. The device may further include a control interface comprising mechanical buttons, touch sensors, or a touchscreen for direct interaction. The device may also be comprised of a smoke detector and an embedded speaker for audible alerts triggered by sensor activity, timers, or mobile input.

The mobile application serves as the main control interface, enabling live video streaming, camera control, timer management, and real-time notifications. The application may further be comprised of an artificial intelligence module for real-time analysis of video and sensor data to detect incidents. Alerts may be issued as push notifications or audio signals. In addition, the application may also include a cooking safety library offering guidelines and best practices.

Accordingly, the cooktop remote-monitoring device of the present invention is particularly advantageous as it provides a user with the ability to monitor stovetop conditions remotely through a rotatable, zoom-capable camera system equipped with visibility enhancements and protective features. The additional possible integration of thermal, optical, acoustic, and gas sensors allows for real-time detection of dangerous or abnormal cooking conditions, while wireless data transmission ensures continuous user engagement regardless of physical proximity to the cooktop. The mobile application interface, combined with automated alert generation and manual control features, thereby addresses the practical need for active stovetop management when direct supervision is not feasible. As a result, the cooktop remote-monitoring device enhances kitchen safety, reduces the likelihood of unattended cooking incidents, and improves overall cooking efficiency.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a cooktop remote-monitoring device of the present invention in accordance with the disclosed architecture;

FIG. 2 illustrates a top perspective view of one potential embodiment of a cooktop remote-monitoring device of the present invention in accordance with the disclosed architecture; and

FIG. 3 illustrates a graphical view of features of a mobile application of one potential embodiment of a cooktop remote-monitoring device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cooktop remote-monitoring device that enables individuals to visually monitor stovetop activities in real time from remote locations. There also exists a long-felt need in the art for a cooktop remote-monitoring device that incorporates environmental and thermal sensors to detect hazardous conditions during cooking. Moreover, there exists a long-felt need in the art for a cooktop remote-monitoring device that provides alert functionalities and remote control features to enhance user responsiveness and cooking safety.

The present invention, in one exemplary embodiment, is comprised of a cooktop remote-monitoring device. The device facilitates real-time visual monitoring, event detection, and remote alert communication during cooking activities. Through remote oversight and automation, the device improves efficiency, enhances kitchen safety, and mitigates risks associated with unattended cooking.

More specifically, the device is comprised of a camera for remote visual monitoring. The camera may be a digital video type and may support features including zoom, wide-angle viewing, night vision, infrared illumination, and automatic exposure. The camera may be enclosed within a hemispherical protective dome, which may rotate horizontally and tilt vertically via at least one motor. Rotation and tilt functions may be controlled manually through a mobile application or autonomously through embedded software that responds to sensor activity. The dome may be comprised of transparent or translucent materials and may feature a hydrophobic nano-coating to minimize condensation, splatter, and steam interference.

At least one environmental sensor may be included in the device and is configured to monitor parameters such as temperature, smoke, humidity, gas presence, and sound. Sensor data may be transmitted to the mobile application via wireless modules including Bluetooth, Wi-Fi, or Zigbee.

The device body may feature a fastener that allows secure attachment to kitchen surfaces. Various fastening methods may be used, including but not limited to magnetic, suction, hook-and-loop, or adhesive mechanisms, with anti-slip and protective materials to prevent surface damage. An alternative configuration may incorporate a detachable adhesive disk with an embedded magnet for repositioning.

Power to the device may be provided by an internal rechargeable battery. Charging may be accomplished through a USB-C port, pogo-pin connector, or wireless coil. The device may further include a power button and LED indicators for displaying battery levels. An integrated display screen may present information such as timers, diagnostics, and sensor alerts. A control interface may also be included, utilizing mechanical buttons, touch sensors, or a touchscreen for direct interaction. The device may further be comprised of a smoke detector and a speaker that delivers audible alerts based on sensor input, timers, or commands from the mobile application.

The mobile application functions as the primary control interface of the device and supports live video streaming, camera manipulation, timer settings, and real-time alert notifications. The application may incorporate an artificial intelligence module capable of analyzing video and sensor data in real time to identify cooking-related anomalies. Alerts may be issued through push notifications or speaker-generated audio signals. A cooking safety library may also be included, offering guidelines and stovetop best practices.

As a result, the device offers a comprehensive solution by enabling users to supervise cooking remotely using a camera system with rotation, zoom, and environmental protections. The integration of various sensors enables immediate identification of unsafe conditions, while wireless connectivity ensures continuous monitoring. The combination of mobile application control, automated alerts, and real-time feedback provides practical functionality when in-person supervision is unavailable. This thereby enhances cooking safety, reduces unattended operation risks, and supports overall kitchen efficiency.

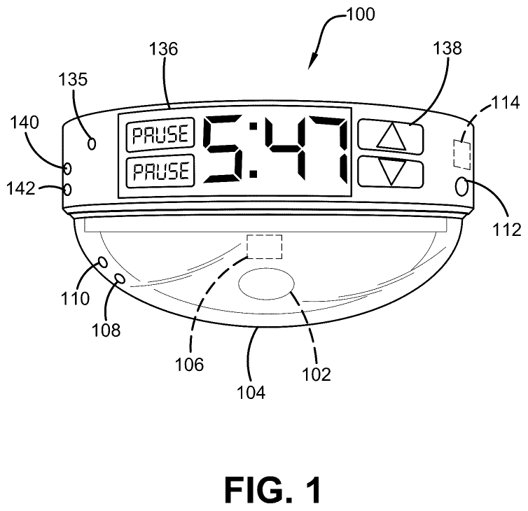

Referring initially to the drawings, FIG. 1 illustrates a front perspective view of one potential embodiment of a cooktop remote-monitoring device 100 of the present invention in accordance with the disclosed architecture. The device 100 is a remote stovetop monitoring device designed to facilitate real-time visual monitoring, event detection, and remote alert communication in relation to stovetop cooking activities. More specifically, the device 100 enables users to observe and manage cooking operations remotely, thereby enhancing kitchen safety, reducing the risks associated with unattended cooking, and improving culinary efficiency through proactive oversight and automation.

The device 100 is comprised of a camera 102. The camera 102 may be any type such as but not limited to a CMOS-based digital video camera, an IP-enabled camera, or a wide dynamic range (WDR) sensor array, etc. The camera 102 may include functionality such as optical zoom, digital zoom enhancement, wide-angle field of view (between 1 and 180°), low-light or night vision capability, infrared illumination, automatic exposure control, etc. In one embodiment, the camera 102 is enclosed within a hemispherical protective dome 104. The protective dome 104 may be configured to provide mechanical shielding and environmental isolation for the camera 102. The dome 104 and/or the camera 102 may be configured for 360-degree horizontal rotation about a vertical axis of the device 100. The rotational mechanism may be driven by at least one motor 106, which may include a stepper motor, servo motor, or brushless DC motor. Control of motor 106 may be achieved through a mobile application 198 or through autonomous behavior governed by embedded software responding to event triggers from onboard sensors (in one embodiment). The camera 102 and/or dome 104 may further be equipped with tilt functionality enabling angular displacement in the vertical plane up to ±45 degrees. The tilt function may facilitate improved observation of cookware placed at different stovetop positions or accommodate for device 100 installation at various heights and orientations.

The dome 104 may be comprised of optically transparent or translucent materials such as but not limited to acrylic, polycarbonate, glass composites, or chemically strengthened silica. In one embodiment, the surface of the dome 104 may be treated with a hydrophobic nano-coating 108 to resist condensation, oil splatter, and steam particulates. The nano-coating 108 may be augmented by a thermal regulation element 110 (as seen in FIG. 1), which may include but is not limited to an embedded resistive heating mesh, a transparent conductive oxide layer, or a phase-change thermal layer that activates at humidity thresholds to maintain optical clarity. The outer surface of the body 116 may be available in multiple color variants and surface finishes 128 such as but not limited to matte-finish polymers, brushed aluminum, anodized metallic coatings, or stainless steel facades to match a wide range of interior kitchen aesthetics.

The device 100 may be comprised of at least one environmental sensor 112 (as seen in FIG. 1) configured to monitor parameters relevant to cooking safety and stove operation. The sensor 112 may be a thermal sensor such as an infrared or thermopile array for detecting surface temperatures and heat anomalies. The sensor 112 may be an optical sensor such as a photodiode or spectrometer for smoke detection or flame pattern recognition. The sensor 112 may be a capacitive or resistive humidity sensor to track vapor buildup. The sensor may be a gas sensor to detect flammable and toxic gases such as methane, propane, carbon monoxide, and hydrogen. Additionally, the sensor 112 may be an acoustic sensor such as a MEMS microphone to enable audio pattern recognition related to boiling, frying, timer alarms, or kitchen-related activities. Sensor 112 outputs may be relayed to the mobile application 198 via at least one wireless transmitter 114, which may include but is not limited to a Bluetooth Low Energy (BLE) module, a Wi-Fi radio transceiver, or a Zigbee module for low-power mesh networking. Wireless transmitter 114 pairing may be accomplished via at least one pairing button 150.

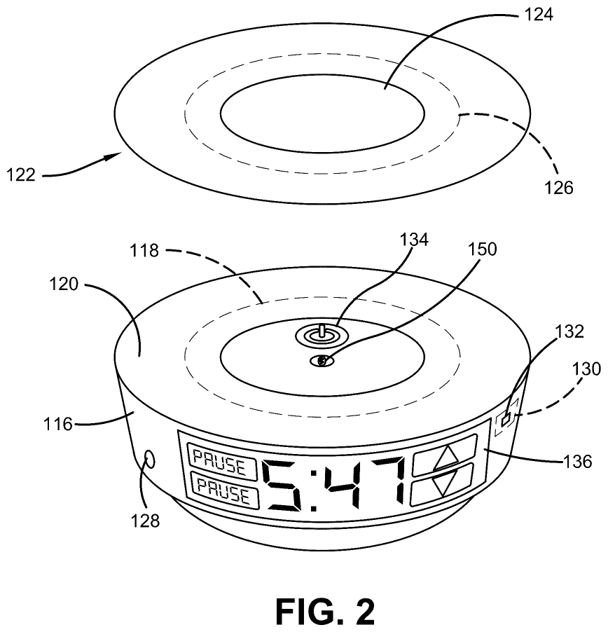

The body 116 of the device 100 may include a fastener 118 (as seen in FIG. 2) configured to securely affix the device 100 to kitchen structures such as but not limited to range hoods, overhead shelves, or appliance surfaces. The fastener 118 may be comprised of magnetic elements, suction mechanisms, hook-and-loop closures, and/or thermally stable adhesive pads. In one embodiment, the fastener 118 is layered with a protective surface 120 such as but not limited to silicone rubber, polyurethane foam, or thermoplastic elastomer (TPE), which provides anti-slip properties and prevents abrasion to the mounting surface. In an alternative embodiment, the device 100 may be comprised of a detachable mounting disk 122 featuring an adhesive backing 124, as seen in FIG. 2. The disk 122 may be manufactured from high-strength, heat-resistant polymers such as polyetherimide or polyphenylene sulfide and may incorporate a centrally embedded magnet 126. This configuration allows magnetic attachment of the device 100 via a magnetic embodiment of the fastener 118, enabling repositioning or relocation of the device based on cooking context or spatial limitations.

Power for the device 100 may be supplied by an internal rechargeable battery 130, which may be a lithium-ion, lithium-polymer cell, etc. The battery 130 may be rechargeable via a charging interface 132 which may include but is not limited to a USB-C port, a magnetic pogo-pin connector, or a wireless inductive charging coil compatible with standardized charging pads. The power interface may further be equipped with a physical power button 134 and an LED-based battery level indicator array 135.

The device 100 may also include an integrated electronic display screen 136 configured to provide real-time information and functionality such as but not limited to countdown timers, system diagnostics, and active sensor warnings. The screen 136 may be comprised of display technologies such as but not limited to liquid crystal display (LCD), organic light-emitting diode (OLED), or electrophoretic e-ink displays for low-power visual feedback. For direct interaction without the mobile interface, the device 100 may be comprised of a control interface 138. This control interface 138 may include but is not limited to tactile mechanical buttons, capacitive touch sensors, and/or a touchscreen, enabling users to manually activate video feeds, reset sensors, or dismiss alerts.

In addition to the aforementioned sensors 112, the device 100 may also be comprised of a smoke detector 140. The smoke detector 140 may be a photoelectric or ionization-based detector. The device 100 may further include an embedded speaker 142 configured to emit audible alerts when triggered by sensor 112 activity, timer expiration, smoke detector 140 activity, and/or or mobile application 198 input.

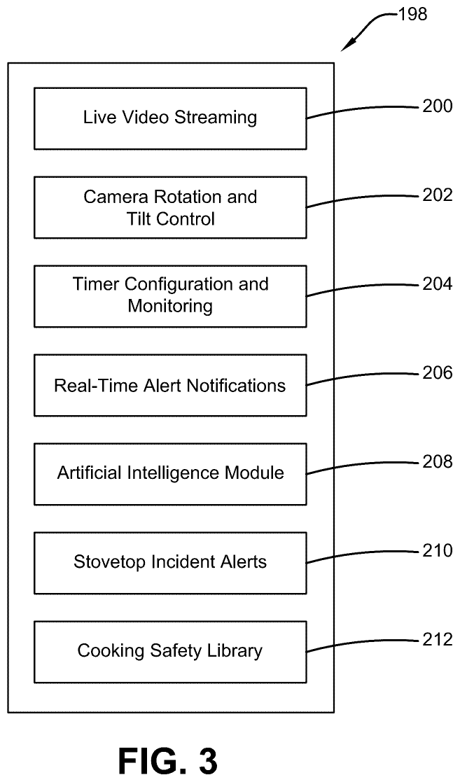

The mobile application 198 may serve as the primary user interface and control hub. As seen in FIG. 3, The application 198 may enable live video streaming (200) from the camera 102, manual or automated camera 102 rotation and tilt control (202), timer configuration and monitoring (204), and real-time alert notifications (206). The application 198 may be comprised of an artificial intelligence module (208) capable of processing video and sensor 112 and detector 140 data in real time, wherein the module (208) may employ machine learning models to detect stovetop incidents such as but not limited to boil-overs, burner malfunctions, or excessive smoke, and may generate alerts (210) in the form of push notifications or audible signals via the speaker 142. Furthermore, the application 198 may include a cooking safety library (212), offering users access to safety guidelines, heat thresholds for various food types, and best practices for stovetop use.

In one embodiment, the device 100 may be optimized for use inside of an oven that may have the same and/or similar components. In other embodiments, the device 100 may be inseparably integrated into an appliance such as but not limited to a range, a range hood, etc. In a further embodiment, the device 100 may be in electrical communication with a stove wherein the device 100 can remotely shut off the stove and/or at least one burner of the stove if a fire and/or other event is detected.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cooktop remote-monitoring device” and “device” are interchangeable and refer to the cooktop remote-monitoring device 100 of the present invention.

Notwithstanding the forgoing, the cooktop remote-monitoring device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cooktop remote-monitoring device 100 as shown in the FIGS. are for illustrative purposes only, and that many other sizes and shapes of the cooktop remote-monitoring device 100 are well within the scope of the present disclosure. Although the dimensions of the cooktop remote-monitoring device 100 are important design parameters for user convenience, the cooktop remote-monitoring device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cooktop remote-monitoring device comprising:
a camera;
a protective dome enclosing the camera;
a motor configured to rotate the camera horizontally;
a sensor;
a wireless transmitter configured to transmit data from the sensor;
a body comprising a fastener;
a battery;
a charging interface;
an electronic display screen; and
a control interface.

2. The cooktop remote-monitoring device of claim 1, wherein the protective dome is comprised of a hydrophobic nano-coating.

3. The cooktop remote-monitoring device of claim 1, wherein the protective dome is comprised of a thermal regulation element.

4. The cooktop remote-monitoring device of claim 1, wherein the sensor is comprised of a thermal sensor, an optical sensor, a humidity sensor, a gas sensor, or an acoustic sensor.

5. The cooktop remote-monitoring device of claim 1 further comprised of a speaker.

6. The cooktop remote-monitoring device of claim 1 further comprised of a smoke detector.

7. The cooktop remote-monitoring device of claim 1, wherein the fastener is comprised of a protective surface.

8. A cooktop remote-monitoring device comprising:
a camera;
a protective dome enclosing the camera;
a motor configured to rotate the camera;
a sensor;
a wireless transmitter configured to transmit data from the sensor;
a body comprising a first fastener;
a battery;
a charging interface;
an electronic display screen;
a control interface; and
a mounting disk comprised of an adhesive backing and a second fastener configured to attach to the first fastener.

9. The cooktop remote-monitoring device of claim 8, wherein the control interface is comprised of a touchscreen.

10. The cooktop remote-monitoring device of claim 8 further comprised of a battery level indicator array.

11. The cooktop remote-monitoring device of claim 8 further comprised of a pairing button.

12. The cooktop remote-monitoring device of claim 8, wherein the sensor is comprised of a thermal sensor, an optical sensor, a humidity sensor, a gas sensor, or an acoustic sensor.

13. The cooktop remote-monitoring device of claim 8 further comprised of a speaker.

14. The cooktop remote-monitoring device of claim 8 further comprised of a smoke detector.

15. The cooktop remote-monitoring device of claim 8, wherein the protective dome is comprised of a hydrophobic nano-coating.

16. A cooktop remote-monitoring device comprising:
a camera;
a protective dome enclosing the camera;
a motor configured to rotate the camera horizontally;
a sensor;
a wireless transmitter configured to transmit data from the sensor;
a body comprising a fastener;
a battery;
a charging interface;
an electronic display screen;
a control interface; and
a mobile application configured to control and receive a live video feed from the camera.

17. The cooktop remote-monitoring device of claim 16, wherein the mobile application generates an alert based on a data from the sensor.

18. The cooktop remote-monitoring device of claim 16, wherein the mobile application is comprised of an artificial intelligence module.

19. The cooktop remote-monitoring device of claim 16, wherein the mobile application configures a timer.

20. The cooktop remote-monitoring device of claim 16, wherein the mobile application is comprised of a cooking safety library.
